(19) United States
(12) Patent Application Publication
(10) Pub. No.: US 2015/0333558 A1
(43) Pub. Date: Nov. 19, 2015

(54) WIRELESS CHARGER UNITS FOR POWERING LOW-COST DISPOSABLE ELECTRONIC SYSTEMS AND RELATED METHODS

(71) Applicant: Avery Dennison Corporation, Mentor, OH (US)

(72) Inventor: Ian James Forster, Essex (GB)

(21) Appl. No.: 14/584,104

(22) Filed: Dec. 29, 2014

Related U.S. Application Data
(60) Provisional application No. 61/992,517, filed on May 13, 2014.

(51) Int. Cl. H02J 7/02; H02J 7/00

(52) U.S. Cl. CPC H02J 7/025; H02J 7/0052; H02J 2007/0059

(57) ABSTRACT

Wireless charger units include a transmitter unit to provide an AC magnetic field at a predetermined frequency to a physically separate receiver unit, the receiver unit receives the alternating current magnetic field, converts the alternating current magnetic field into an alternating current, and rectifies the alternating current to provide a direct current output. The receiver unit can be resonant at a multiple integer of the predetermined frequency. The electronic device may be a disposable and may include a blister pack for pills with the receiver unit monitoring the usage of the pills. The receiver unit may also include an intelligent controller. Related methods are disclosed.

### CROSS-REFERENCE TO RELATED APPLICATION(S)

The present application claims priority from U.S. Provisional Application No. 61/992,517 filed May 13, 2014 which is incorporated by herein by reference in its entirety.

### FIELD OF THE DISCLOSURE

The present subject matter relates to supplying electrical power to electronic devices. More particularly, the present subject matter relates to use of a wireless charger unit for powering electronic devices by converting an AC magnetic field into an AC electrical field. These units and attendant methods are particularly suitable for disposable electronic systems.

### DESCRIPTION OF RELATED ART

Electrical power is frequently directly supplied to electronic devices by a suitable power supply, battery, or the like. However, power supplies tend to be bulky and are not cost effective for disposable electronic devices. Batteries have lifetime issues and may need periodic recharging. Furthermore, the size of batteries may make their combination with disposable electronic devices impractical.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a method is provided for providing electrical power to an electronic device from a wireless charger unit. The method includes the steps of providing an alternating current magnetic field at a predetermined frequency from a transmitter unit to a physically separate receiver unit, receiving the alternating current magnetic field at the receiver unit, converting the alternating current magnetic field into an alternating current, and rectifying the alternating current to provide a direct current output to the electronic device. Preferably, the receiver unit is resonant at the predetermined frequency of the alternating current magnetic field or at a multiple integer of the predetermined frequency.

In another aspect, a method is provided for supplying the direct current output to the electronic device, receiving the alternating current magnetic field from the transmitter unit at a coil in the receiver unit and converting the alternating current magnetic field into an alternating current, or receiving the alternating current magnetic field from the transmitter unit at a field conversion device in the receiver unit and converting the alternating current magnetic field into an alternating current electrical field.

In yet another aspect, a method is provided for supplying the direct current output to an oscillator, the oscillator operating at a frequency which is an integer multiple of the frequency of the alternating current magnetic field; and coupling the output of the oscillator to one or more conductive areas thereby creating an electrical field.

In embodiments, the electronic device is a disposable electronic device, and the disposable electronic device may include a blister pack for pills with the receiver unit monitoring the usage of the pills. The receiver unit may additionally include an intelligent controller.

In a further aspect, apparatus in the form of a wireless charger unit provides electrical power to an electronic device. The wireless charger unit includes a transmitter unit to provide an alternating current magnetic field at a predetermined frequency from the transmitter unit to a physically separate receiver unit, the receiver unit receives the alternating current magnetic field, the receiver unit converts the alternating current magnetic field into an alternating current, and the receiver unit rectifies the alternating current to provide a direct current output. Preferably, the receiver unit is resonant at the predetermined frequency or at a multiple integer of the predetermined frequency. The direct current output of the receiver unit may be supplied to the electronic device.

In yet a further aspect, embodiments with a coil in the receiver unit receive the alternating current magnetic field from the transmitter unit and convert the alternating current magnetic field into an alternating current, or an oscillator may be coupled to the direct current output, with the oscillator operating at a frequency which is an integer multiple of the frequency of the alternating current magnetic field and one or more conductive areas are coupled to an output of the oscillator thereby creating an electrical field.

### BRIEF DESCRIPTION OF THE DRAWINGS

FIG. 1 is a schematic diagram illustrating a wireless charging system in which a transmitter unit supplies electrical power to a receiver unit;

FIG. 2 is a pictorial diagram illustrating a wireless magnetic transmitter magnetically coupled to a field conversion device;

FIG. 3a is a schematic diagram illustrating further details of an embodiment of the field conversion device shown in FIG. 2;

FIG. 3b is a schematic diagram illustrating an alternative embodiment of the field conversion device shown in FIG. 2;

FIG. 4 is a schematic diagram illustrating a combined magnetic field and electrical field wireless power coupler; and

FIG. 5 is a schematic diagram illustrating an application of the wireless supply of electrical power to a disposable device.

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

This disclosure is concerned with devices which convert the AC magnetic field output of standard wireless chargers, such as those conforming to the “QI” standard, into an AC electrical field which is more suitable to power low cost disposable electronic devices. This eliminates the need for a more expensive and bulky coil with a large number of turns to provide resonance at the AC frequency.

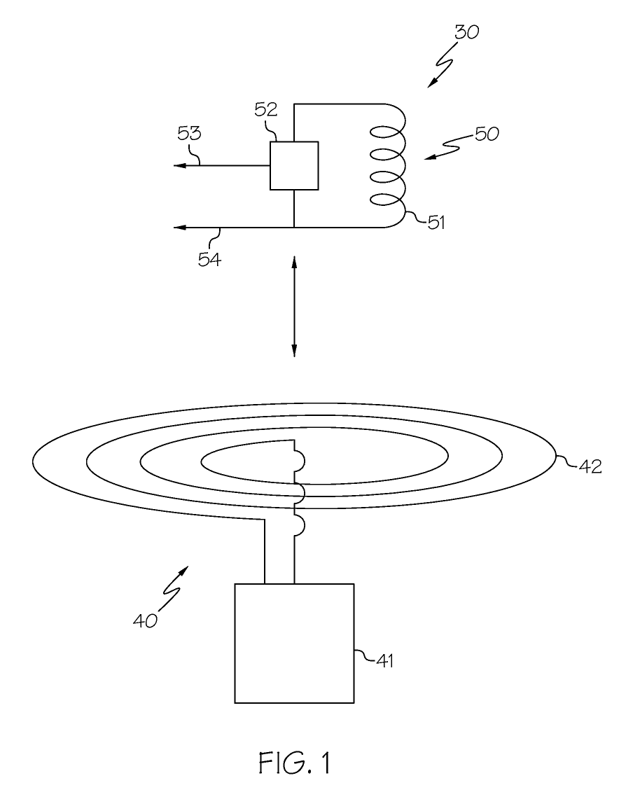

In the embodiment of FIG. 1, a basic wireless charger system, generally designated 30, is shown. The charger system 30 includes a transmitter unit 40 and a receiver unit 50, which are physically separate units. Receiver unit 50 may be remotely located from transmitter unit 40. Transmitter unit 40 typically includes an electrical module 41 and a transmitting antenna or coil 42. Receiver unit 50 includes a coil 51 and a power conditioning circuit 52. Power conditioning circuit 52 will typically include rectifiers to convert the AC current induced in coil 51 to a DC voltage at power supply terminals 53-54. Power conditioning circuit 52 may also include additional circuitry to smooth or filter the DC output at terminals 53-54, such as capacitors, voltage regulators, or the like. The DC voltage at terminals 53-54 may then be used to supply power to an electronic device.

In operation, transmitter module 41 supplies an AC current at a frequency “F” to its coil 42 which establishes a magnetic field about the coil. This magnetic field provides magnetic energy to coil 51 of the receiver unit 50. This AC magnetic field about coil 51 results in an AC current in coil 51, which is converted to a DC voltage at power supply terminals 53-54 by the power conditioning circuit 52. Preferably, receiver unit 50 is resonant, or close to resonance, at frequency “F”, or at a multiple of the frequency “F”, for efficient energy transfer between the transmitter unit and the receiver unit. If desired, the receiver unit 50 may be supplied with additional circuitry to communicate with the transmitter unit 40 to assist in regulating the energy transfer.

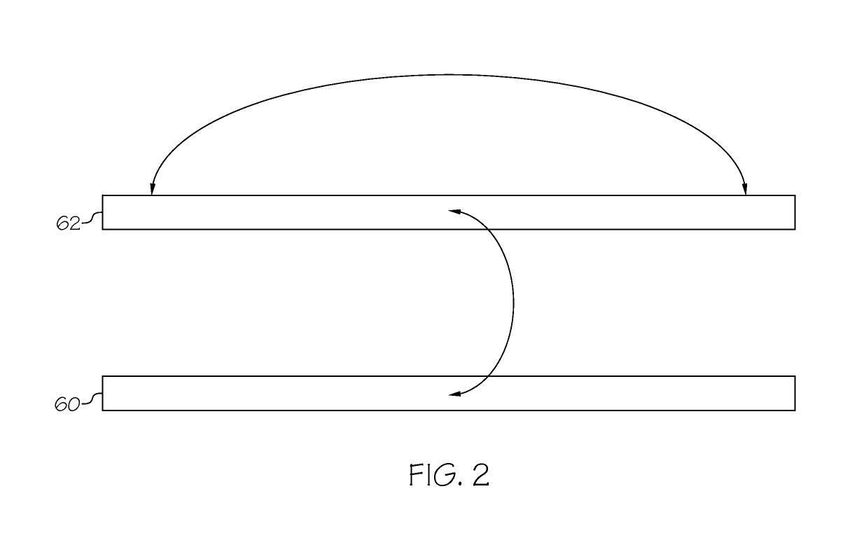

Another embodiment shown in FIG. 2 provides magnetic coupling between a wireless magnetic transmitter 60 and a field conversion device 62 at a frequency “F”. Again, the wireless magnetic transmitter and the field conversion device are physically separate devices, and they may be located remotely from each other. The magnetic coupling establishes a high electrical field in the field conversion device. The electrical field may be at the same frequency “F”, or at a multiple of the drive frequency “F”.

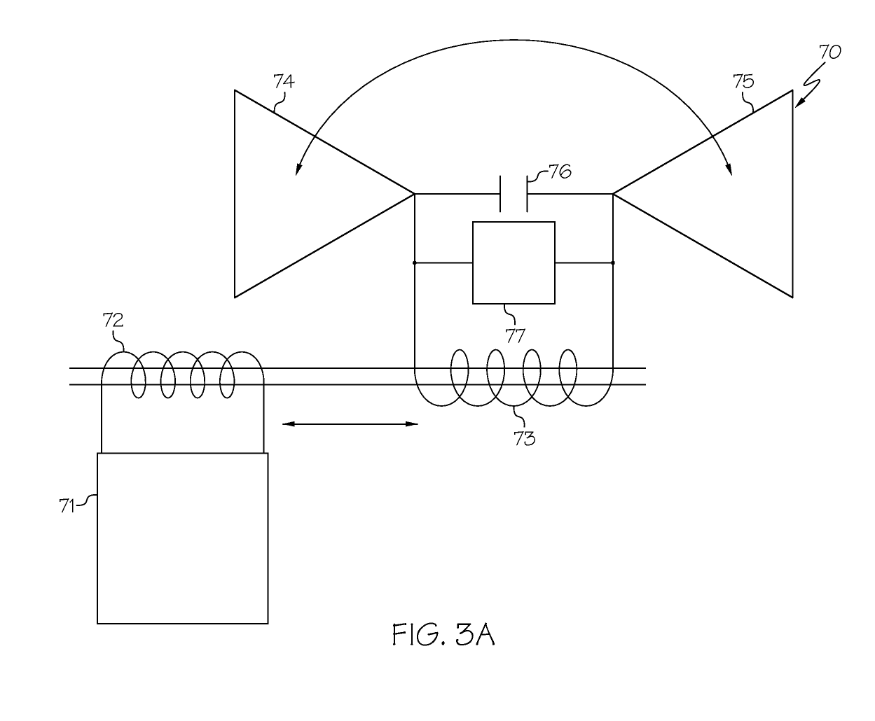

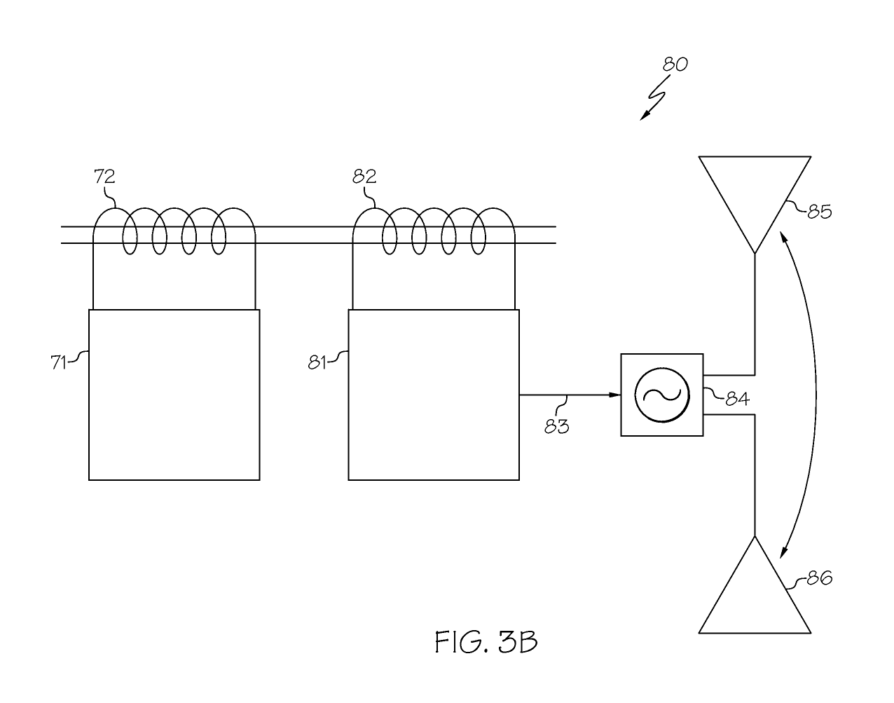

FIG. 3a shows an embodiment of a field conversion device 70 in greater detail than the field conversion device 62 in FIG. 2. A transmitter 71 provides magnetic flux at a frequency “F” via a coil 72. A coil 73 of the field conversion device 70 is magnetically coupled to the coil 72 of the transmitter. A pair of conductive areas 74 and 75 is connected to opposite ends of the coil 73. A capacitor 76 is also connected across the coil 73. In a manner known in the art, the capacitive value of capacitor 76 and the inductance of coil 73 will determine the resonant frequency of the field conversion device 70. Preferably, the resonant frequency of the field conversion device 70 is the frequency “F” of the transmitter 71 or an integer multiple thereof. An intelligent controller 77 may also be connected across coil 73 to provide operational information about the field conversion device 70, and to provide control thereof. In operation, a high electrical field can be established between the conductive areas 74-75.

In another embodiment, an alternative embodiment of the field conversion device 70 of FIG. 3a, is shown in FIG. 3b. A magnetic transmitter 71, with its coil 72, generates a magnetic field at frequency “Fh”. Coil 82 of receiver unit 81 receives the magnetic field. An alternating current induced in coil 82 is rectified by a DC power supply and the DC power is supplied to an oscillator 84 on a line 83. Oscillator 84 then operates at a frequency “Fe”, and the output of the oscillator is applied to one or more conductive areas, such as conductive areas 85, 86. Preferably, the frequency “Fe” of the oscillator 84 is an integer multiple of the frequency “Fh” of the magnetic field. By using a higher oscillator frequency “Fe”, the electrical field coupling, essentially by capacitance, is greater for a given area.

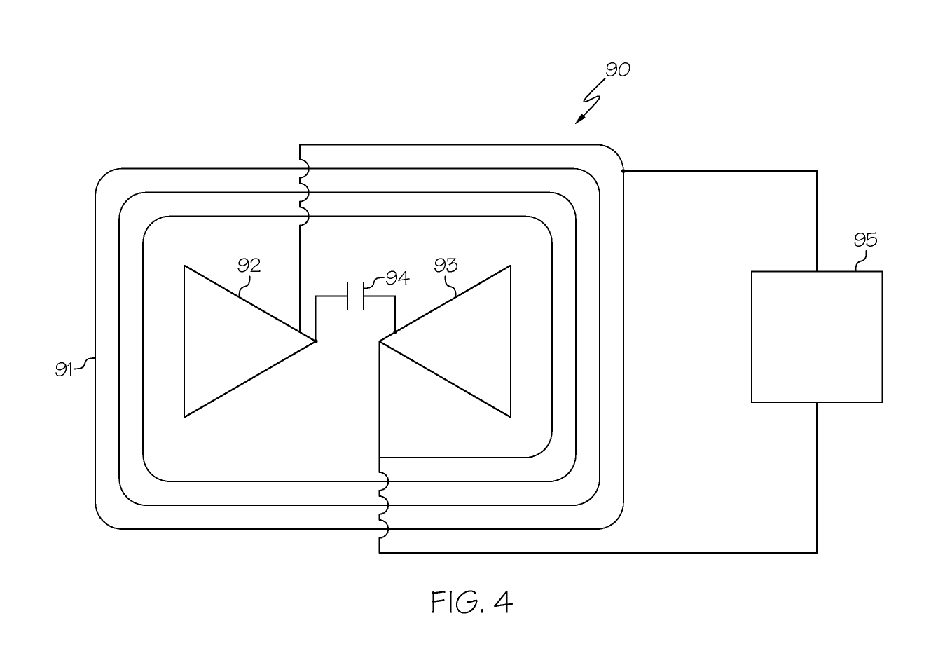

FIG. 4 shows an embodiment of a wireless power coupler, generally designated 90, which utilizes combined electrical (E) field and magnetic (H) field. The wireless power coupler may be capable of conforming to a standard, such as “QI”, for the magnetic portion. A spiral winding or coil 91 has opposite ends respectively connected to conductive areas 92 and 93. A capacitor 94 is connected between the conductive areas. A driver circuit 95 activates the wireless power coupler. In operation, an electrical field is created by taking the resonant voltage across the coil 91 and coupling it to one or more suitable areas 92, 93 on the charger surface.

The present invention includes converting the magnetic field to an electric field using a secondary device. Through using a secondary device that converts to an electric field and also changes the frequency, the invention creates a modified magnetic wireless charger that also generates an electric field at the same frequency. The device of FIG. 4 where the electric field is generated at a higher frequency that may or may not be a integer multiple which for disposable electronics, E field coupling has lower complexity and hence lower costs than H field, particularly at higher frequencies.

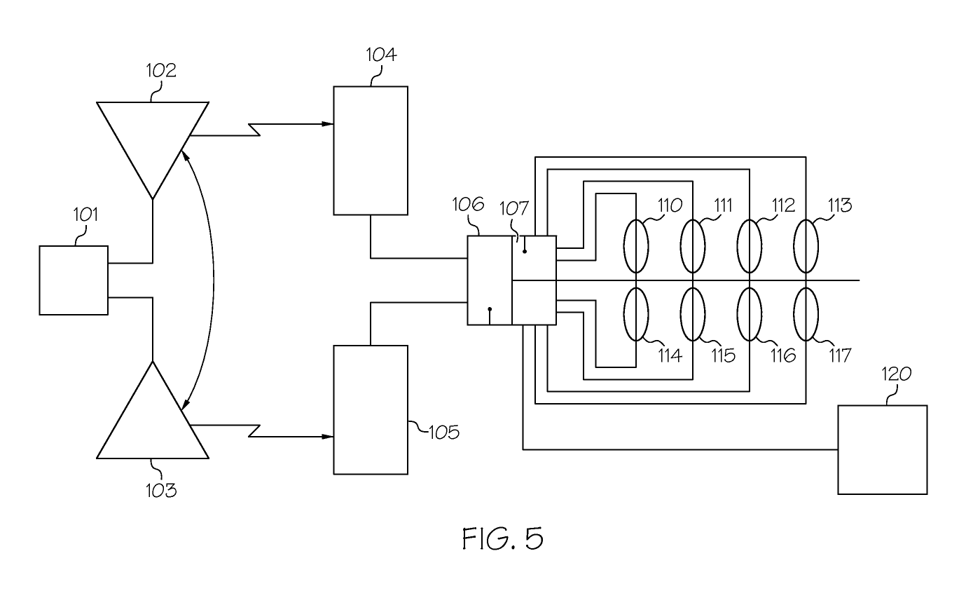

An embodiment of the use of the present disclosure is shown in FIG. 5, which is concerned with monitoring the removal of pills from a blister pack. An electrical field transmitter 101 with a differential electrical field between conductive areas 102, 103 supplies electrical power to conductive areas 104, 105 via capacitive coupling. A receiver portion 106 has rectifiers to generate electrical power from the differential voltage induced in areas 104-105. A plurality of conductive areas 110, 111,112,113, 114, 115, 116 and 117 are disposed over portions of a pill blister pack such that removal of a pill from the blister pack will fracture one of the conductive areas and render the fractured area non-conductive. A switch decoder 107, disposed in the receiver portion 106, will detect the non-conductive condition of the fractured area and report the removed pill condition to a communication unit 120. Communication unit 120 may, in turn, periodically report the removed pill to a host system, to medical personnel, or to an appropriate supervisor such that compliant medication usage can be monitored.

The use of electric field coupling in FIG. 5 enables the device to operate without a battery, which avoids the attendant lifetime and recharging issues associated with batteries. Communication between communication unit 120 and the host system may be via a WiFi network or via a Bluetooth enabled device, such as a mobile phone. The mobile phone may, in turn, be powered by the magnetic field emission. Use of the electrical field coupling makes the disposable element lower in cost since a multi-turn coil, which must include a crossover, is not required. Instead, simply two areas 104-105 of conductor suffice since these areas do not carry significant current and may be a printed material such as silver or carbon based inks.

Similar enablements are achieved when the technology of this disclosure is incorporated into other embodiments in which a breach is detected and reported besides blister packs and the like. Also, other embodiments besides those monitoring physical breaks between surfaces or components are possible where a powering objective needs to be addressed in a low-cost and/or disposable manner.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof including as combinations of features that are individually disclosed or claimed herein.

1. A method for providing electrical power to an electronic device from a wireless charger unit, said method comprising the steps of:
providing an alternating current magnetic field at a predetermined frequency from a transmitter unit to a physically separate receiver unit;
receiving the alternating current magnetic field at the receiver unit;
said receiver unit being resonant at the predetermined frequency or at a multiple integer of the predetermined frequency;
converting the alternating current magnetic field into an alternating current; and rectifying
the alternating current to provide a direct current output.

2. The method of claim 1, further comprising the step of: supplying the
direct current output to the electronic device.

3. The method of claim 1, wherein
a coil in the receiver unit receives the alternating current magnetic field from the transmitter unit and converts the alternating current magnetic field into an alternating current.

4. The method of claim 1, wherein
a field conversion device in the receiver unit which receives the alternating current magnetic field from the transmitter unit and converts the alternating current magnetic field into an alternating current electrical field.

5. The method of claim 1, further comprising the steps of:
supplying the direct current output to an oscillator, said oscillator operating at a frequency which is an integer multiple of the frequency of the alternating current magnetic field; and
coupling the output of the oscillator to one or more conductive areas thereby creating an electrical field.

6. The method of claim 1, wherein
the electronic device is a disposable electronic device.

7. The method of claim 6, wherein
the disposable electronic device includes a blister pack for pills and the receiver unit monitors the usage of the pills.

8. The method of claim 1, wherein
the receiver unit includes an intelligent controller.

9. A wireless charger unit for providing electrical power to an electronic device, said wireless charger unit comprising:
a transmitter unit to provide an alternating current magnetic field at a predetermined
frequency from the transmitter unit to a physically separate receiver unit; the receiver unit
receives the alternating current magnetic field;
said receiver unit is resonant at the predetermined frequency or at a multiple integer of the predetermined frequency;
the receiver unit converts the alternating current magnetic field into an alternating current; and
the receiver unit rectifies the alternating current to provide a direct current output.

10. The wireless charger unit of claim 9, wherein
the direct current output of the receiver unit is supplied to the electronic device.

11. The wireless charger unit of claim 9, further comprising:
a coil in the receiver unit to receive the alternating current magnetic field from the transmitter unit and to convert the alternating current magnetic field into an alternating current.

12. The wireless charger unit of claim 9, further comprising:
a field conversion device in the receiver unit which receives the alternating current magnetic field from the transmitter unit and converts the alternating current magnetic field into an alternating current electrical field.

13. The wireless charger unit of claim 9, further comprising:
an oscillator, the oscillator coupled to the direct current output, said oscillator operating at a frequency which is an integer multiple of the frequency of the alternating current magnetic field; and
one or more conductive areas coupled to an output of the oscillator thereby creating an electrical field.

14. The wireless charger unit of claim 9, wherein
the electronic device is a disposable electronic device.

15. The wireless charger unit of claim 14, wherein
the disposable electronic device includes a blister pack for pills and the receiver unit monitors the usage of the pills.

16. The wireless charger unit of claim 9, wherein
the receiver unit includes an intelligent controller.
